(19) United States
(12) Patent Application Publication
(10) Pub. No.: US 2010/0052218 A1
(43) Pub. Date: Mar. 4, 2010

(54) Gas Recirculation Heat Exchanger For Casting Silicon

(75) Inventors: Roger F. Clark, Knoxville, MD (US); Raymond J. Roberts, Moorestown, NJ (US)

Correspondence Address: CAROL WILSON;BP AMERICA INC., MAIL CODE 5 EAST, 4101 WINFIELD ROAD, WARRENVILLE, IL, 60555, US

(73) Assignee: BP Corporation North America Inc, Warrenville, IL (US)

(21) Appl. No.: 12/548,065

(22) Filed: Aug. 26, 2009

Related U.S. Application Data
(60) Provisional application No. 61/143,018, filed on Jan. 7, 2009.
(60) Provisional application No. 61/092,186, filed on Aug. 27, 2008.

(51) Int. Cl. B28B 1/14; F28D 15/00

(52) U.S. Cl. 264/299; 249/79; 165/104.34

(57) ABSTRACT

This invention relates to a system and a method of use for a gas recirculation heat exchanger to cast high purity silicon and/or grow crystals. The heat exchanger includes a hot surface for thermal contact with a crucible along with an inlet for flowing a gas to the heat exchanger and an outlet for flowing the gas from the heat exchanger. The exchanger also includes a baffle dividing the inlet from the outlet and for directing at least a portion of the gas over the hot surface, and a recirculation system adapted to cool the gas and return the gas to the heat exchanger. The heat exchanger can be easily tailored to local cooling needs.

This application claims the benefit of U.S. Provisional Application No. 61/143,018, filed Jan. 7, 2009, and U.S. Provisional Application No. 61/092,186 filed Aug. 27, 2008, the entirety of both are expressly incorporated herein by reference.

### BACKGROUND

1. Technical Field

This invention relates to a system and a method of use for a gas recirculation heat exchanger to cast high purity silicon and grow crystals.

2. Discussion of Related Art

Photovoltaic cells convert light into electric current. One of the most important features of a photovoltaic cell is its efficiency in converting light energy into electrical energy. Although photovoltaic cells can be fabricated from a variety of semiconductor materials, silicon is generally used because it is readily available at reasonable cost, and because it has a suitable balance of electrical, physical, and chemical properties for use in fabricating photovoltaic cells.

In a known procedure for the manufacture of photovoltaic cells, silicon feedstock is doped with a dopant having either a positive or negative conductivity type, melted, and then crystallized by pulling crystallized silicon out of a melt zone into ingots of monocrystalline silicon (via the Czochralski (CZ) or float zone (FZ) methods). For a FZ process, solid material is fed through a melting zone, melted upon entry into one side of the melting zone, and re-solidified on the other side of the melting zone, generally by contacting a seed crystal.

Recently, a new technique for producing monocrystalline or geometric multicrystalline material in a crucible solidification process (i.e. a cast-in-place or casting process) has been invented, as disclosed in U.S. patent application Ser. Nos.: 11/624,365 and 11/624,411, and published in U.S. Patent Application Publication Nos.: 20070169684A1 and 20070169685A1, filed Jan. 18, 2007. Casting processes for preparing multicrystalline silicon ingots are known in the art of photovoltaic technology. Briefly, in such processes, molten silicon is contained in a crucible, such as a quartz crucible, and is cooled in a controlled manner to permit the crystallization of the silicon contained therein. The block of cast crystalline silicon that results is generally cut into bricks having a cross-section that is the same as or close to the size of the wafer to be used for manufacturing a photovoltaic cell, and the bricks are sawn or otherwise cut into such wafers. Multicrystalline silicon produced in such manner is composed of crystal grains where, within the wafers made therefrom, the orientation of the grains relative to one another is effectively random. Monocrystalline or geometric multicrystalline silicon has specifically chosen grain orientations and (in the latter case) grain boundaries, and can be formed by the new casting techniques disclosed in the above-mentioned patent applications by melting in a crucible the solid silicon into liquid silicon in contact with a large seed layer that remains partially solid during the process and through which heat is extracted during solidification, all while remaining in the same crucible. As used herein, the term ‘seed layer’ refers to a crystal or group of crystals with desired crystal orientations that form a continuous layer. They can be made to conform to one side of a crucible for casting purposes.

In order to produce high quality cast ingots, several conditions should be met. Firstly, as much of the ingot as possible should have the desired crystallinity. If the ingot is intended to be monocrystalline, then the entire usable portion of the ingot should be monocrystalline, and likewise for geometric multicrystalline material. Secondly, the silicon should contain as few imperfections as possible. Imperfections can include individual impurities, agglomerates of impurities, intrinsic lattice defects and structural defects in the silicon lattice, such as dislocations and stacking faults. Many of these imperfections can cause a fast recombination of electrical charge carriers in a functioning photovoltaic cell made from crystalline silicon. This can cause a decrease in the efficiency of the cell.

Many years of development have resulted in a minimal amount of imperfections in well-grown CZ and FZ silicon. Dislocation free single crystals can be achieved by first growing a thin neck where all dislocations incorporated at the seed are allowed to grow out. The incorporation of inclusions and secondary phases (for example silicon nitride, silicon oxide or silicon carbide particles) is avoided by maintaining a counter-rotation of the seed crystal relative to the melt. Oxygen incorporation can be lessened using magnetic CZ techniques and minimized using FZ techniques as is known in the industry. Metallic impurities are generally minimized by being segregated to the tang end or left in the potscrap after the boule is brought to an end.

However, even with the above improvements in the CZ and FZ processes, there is a need and a desire to produce high purity crystalline silicon that is less expensive on a per volume basis, needs less capital investment in facilities, needs less space, and/or less complexity to operate, than known CZ and FZ processes. There is a need and a desire to improve safety and reliability of silicon casting. There is a need and a desire to cast silicon without a line-of-sight path (physically isolated) for molten silicon to reach a cold wall (water-cooled) in the event of a breach within a casting station. There is also a need and a desire to provide heat integration and/or thermal recovery during the silicon casting process. There is also a need and a desire for devices and processes with increased silicon output and/or additional capacity than conventional devices and processes.

### SUMMARY

This invention relates to a system and a method of use for a gas recirculation heat exchanger to cast high purity silicon and grow crystals. This invention provides improved safety and reliability of silicon casting, such as casting silicon without a line-of-sight path (physically isolated) for molten silicon to reach a cold wall (water-cooled) in the event of a breach within a casting station. This invention also provides heat integration and/or thermal recovery during the silicon casting process. This invention also provides devices and processes with increased silicon output (shortened cycle times) and/or additional capacity than conventional devices and processes.

According a first embodiment, this invention relates a gas circulating heat exchanger suitable for use in producing high purity silicon. The exchanger includes a hot surface for thermal contact with a crucible along with an inlet for flowing a gas to the heat exchanger and an outlet for flowing the gas from the heat exchanger. The exchanger also includes a baffle dividing the inlet from the outlet and for directing at least a portion of the gas onto or over the hot surface, and a recirculation system adapted to cool the gas and return the gas to the heat exchanger.

According to a second embodiment, this invention relates to a casting apparatus suitable for use in producing high purity silicon. The apparatus includes a crucible for containing a feedstock, and a first heat exchanger in thermal contact with at least a portion of the crucible. The apparatus also includes a second heat exchanger in thermal contact with a heat sink and in fluid communication with the first heat exchanger, and a motive force device in fluid communication with the first heat exchanger and the second heat exchanger, for circulating a gaseous heat transfer fluid. The first heat exchanger includes a graphite hot surface for contact with the crucible, an inlet for flowing the gaseous heat transfer fluid to the heat exchanger, an outlet for flowing the gaseous heat transfer fluid from the heat exchanger, and a baffle dividing the inlet from the outlet and for directing at least a portion of the gaseous heat transfer fluid onto the hot surface.

According to a third embodiment, this invention relates to a method of cooling a material suitable for use in producing high purity silicon. The method includes the step of contacting thermally a first heat exchanger with at least a portion of a crucible, and the step of flowing a gaseous heat transfer fluid through the first heat exchanger with a motive force device. The method also includes the step of heating the gaseous heat transfer fluid in the first heat exchanger to cool a material within the crucible by conducting heat through the at least a portion of the crucible and the first heat exchanger, and the step of flowing the gaseous heat transfer fluid to a second heat exchanger. The method also includes the step of cooling the gaseous heat transfer fluid in the second heat exchanger by contacting thermally with a heat sink, and the step of repeating the above steps to recirculate the gaseous heat transfer fluid. The flowing through the first heat exchanger includes passing through an inlet header for a tailored gas flow and passing through an outlet header for a tailored gas flow.

According to a fourth embodiment, this invention includes a high purity silicon ingot made using the apparatus and/or the method of this invention and the ingot suitable for use in solar cells and solar modules.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. In the drawings:

FIG. 1 illustrates a side sectional view of a casting apparatus, according to one embodiment;

FIG. 2 illustrates a side sectional view of a heat exchanger, according to one embodiment;

FIG. 3 illustrates a bottom view of a heat exchanger, according to one embodiment; and

FIG. 4 illustrates a top view of a perforated plate, according to one embodiment.

### DETAILED DESCRIPTION

This invention relates to a system and a method of use for a gas recirculation heat exchanger to cast high purity silicon and/or grow crystals. According to one embodiment, the gas recirculating heat exchanger can replace the large graphite block or thin graphite insulating layer that act as a radiation moderator to the cold wall of the known casting furnaces. The conventional graphite block achieves temperatures of greater than about 1,300 degrees Celsius and then radiates to a 25 degree Celsius water-cooled wall or heat sink. This large temperature difference (greater than about 1,200 degrees Celsius) increases the risk of excess heat or temperature reaching the water-cooled wall, as well as allowing a hot path for liquid silicon to travel to or reach the water-cooled wall. Contacting molten silicon with water-cooled elements may result in safety and/or reliability issues, such as reduced capacity or lost throughput of cast silicon.

Desirably, the gas recirculating heat exchanger can isolate the hot area from the water cooled sections and does not allow a direct path to water for the primary heat removal mechanism. Removing the direct path of the molten silicon to the water-cooled elements increases a safety factor, if a molten or liquid silicon breach and/or spill occur. The moderation can be accomplished by changing a mass flow rate of heat transfer fluid, such as by changing a blower speed through a variable frequency drive, moving a position of control valve (damper) with an actuator, and/or the like. The heat transfer fluid may include any suitable liquid or gas. The gas may be any suitable substances, such as argon, helium, nitrogen, and/or mixtures or combinations thereof.

The use of a non-water primary heat transfer medium allows the capability to recover high quality heat that could be transferred to other media, such as steam or high temperature fluid for use in secondary power generation and/or waste heat recovery. Known systems that use water as the primary fluid achieve only a 35 degree Celsius outlet temperature which degrades the enthalpy to a low value and does not allow secondary uses.

According to one embodiment, the gas recirculating heat exchange system provides variable heat extraction from high temperatures, where the use of water or other vaporizable fluids could present an undue risk of explosion. A high primary coolant temperature allows process heat recovery or power generation. This invention can provide localized heat extraction from several different processes and the factor of safety to isolate direct exposure to water from a hot body. Suitable materials may include graphite for the heat exchanger and argon for the heat transfer medium.

The heat exchanger of this invention may include inlet pipes and outlet pipes, such as to provide a fully enclosed or sealed cooling gas path or circuit. The cooling gas path may be independent of the other elements of the silicon casting system, such as the inert gas blanketing system over the surface of the molten silicon.

According to one embodiment, the cooling gas path may allow or provide easier and/or more reliable separation of the gas in the cooling loop from the gas in contact with the liquid silicon. Gas in contact with the liquid silicon may contain silicon monoxide, a gaseous product of the reaction between the liquid silicon and the silica crucible, for example.

Mixing or cross contamination of the two separate gas volumes can allow silicon monoxide contaminated gas to enter the heat exchanger loop and can lead to solid silicon monoxide deposited on the heat transfer surfaces of the heat exchangers. Silicon monoxide can degrade or reduce heat transfer capability, resulting in decreased productivity and/or a reduced quality silicon ingot.

In the alternative, the apparatus of this invention may provide a portion of the cooling gas flow to or across the molten silicon, such as for an inert atmosphere. The recirculation system may include filters, traps, and/or the like, such as to remove silicon monoxide and/or other potential contaminants or undesired components.

According to one embodiment, the construction of the casting apparatus further facilitates easy insertion and/or removal of the first heat exchanger for cleaning or replacement.

Desirably, a baffle plate or a perforated plate may include holes or jets, such as for impinging at least a portion of the gas flow into a hot surface. The perforated plate can be modified and/or replaced, such as with a different pattern of hole locations and/or sizes. The design of the heat exchanger can provide an easy way for the heat extraction across a bottom of a crucible to be locally tailored, such as to optimize a solidification pattern of the silicon ingot.

Further tailoring of the heat extraction pattern may readily be obtained, such as by modifying the shape of the generally conical inlet connection and/or the size and/or shape of the discharge path at the sides of the heat exchanger. Optionally and/or additionally, the heat extraction pattern may be modified by selectively applying thermal insulation to portions of the inlet and outlet gas paths.

During the solidification process, the solidification front may be advanced at any suitable rate and/or shape. The faster or greater the cooling rate then the resulting shorter cycle times may produce an additional volume of silicon from the same apparatus. If cooling proceeds too quickly, a quality of the ingot may be reduced (disturbing crystallization).

According to one embodiment, the gas cooled heat exchanger and crucible includes a cycle time that is less than a conventional radiation cooled heat exchanger and crucible, such as cycle time ratio of about 0.1 to about 1.0 (gas cooled to conventional radiation cooled), about 0.2 to about 1.0, about 0.5 to about 1.0, about 0.75 to about 1.0, about 0.9 to about 1.0, and/or the like.

The solidification front may include any suitable shape, such as from generally convex to generally concave. The shape of the solidification front may be controlled and/or adjusted during different stages of casting or crystallization.

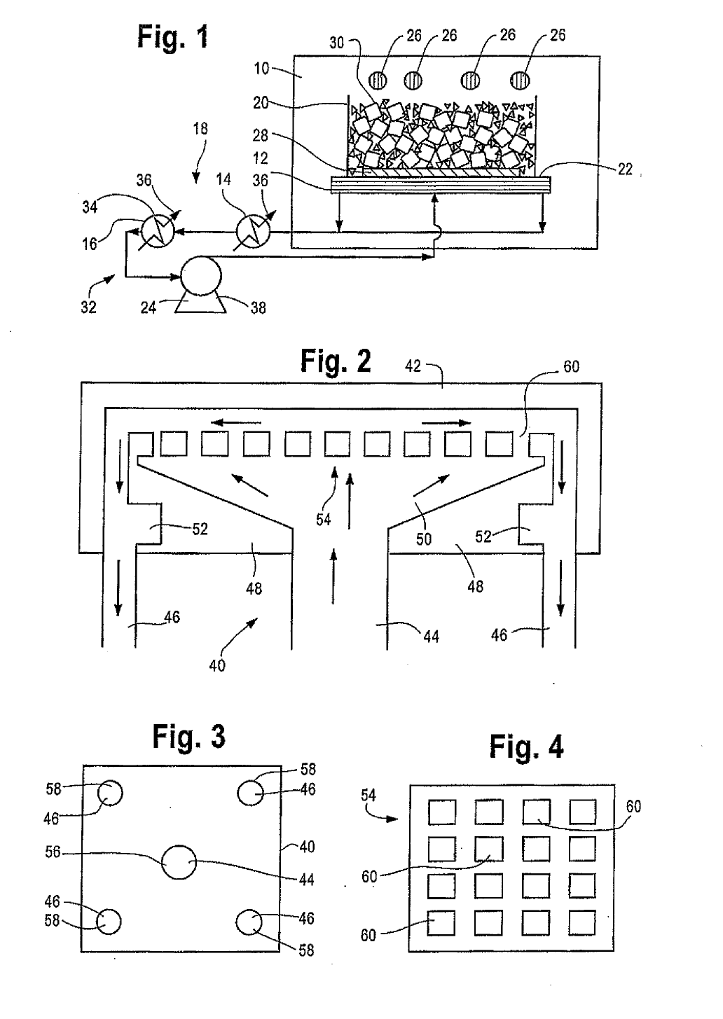

FIG. 1 shows a side sectional view of a casting apparatus 10, according to one embodiment. The casting apparatus 10 includes a first heat exchanger 12, a second heat exchanger 14, and optionally a third heat exchanger 16, such as to form a cascade 18 of heat transfer devices for heat recovery. The casting apparatus 10 includes a crucible 20 with a bottom 22 for holding or containing a feedstock 30 and optionally a seed layer 28. The casting apparatus 10 also includes a motive force device 24, such as in fluid communication with the heat exchangers 12, 14, and 16. The casting apparatus may include one or more heaters 26, such as for melting the feedstock 30.

A recirculation system 32 may include a cooler 34 and a circulating device 38. A heat sink 36, such as flowing cooling water, boiler feedwater, air, and/or the like, is shown by the representative arrows from the heat exchangers 14 and 16.

FIG. 2 shows a side sectional view of a heat exchanger 40, according to one embodiment. The heat exchanger 40 includes a hot surface 42 with an inlet 44 separated from an outlet 46 by a baffle 48. The baffle 48 may include a generally triangular shape. The inlet 44 connects with an inlet header 50 to supply the flow of the gaseous heat transfer fluid as represented by arrows. The outlet 46 connects with an outlet header 52 to collect the flow of the gaseous heat transfer fluid from the hot surface 42. Desirably, a perforated plate 54 including a series of apertures 60 distributes the gaseous heat transfer fluid along or against a side of the hot surface 42. The apertures 60 may be aligned generally in rows and columns, such as to form a grid.

FIG. 3 shows a bottom view of a heat exchanger 40, according to one embodiment. The heat exchanger 40 includes the inlet 44, such as arranged or configured as a central gas entry 56. The heat exchanger 40 also includes the outlets 46, such as arranged or configured as corner gas exits 58. The inlet 44 and the outlets 46 may be arranged generally as the spots on one side of a die. The central gas entry 56 and the four corner gas exits 58 may maximize cooling, control distribution of cooling, and/or minimize pressure drop, for example.

FIG. 4 shows a top view of a perforated plate 54, according to one embodiment. The perforated plate 54 includes apertures 60, such as for allowing or passing the gaseous heat transfer fluid to and/or across a portion of the hot surface 42 (not shown).

Moreover, although casting of silicon has been described herein, other semiconductor materials and nonmetallic crystalline materials may be cast without departing from the scope and spirit of the invention. For example, the inventors have contemplated casting of other materials consistent with embodiments of the invention, such as germanium, gallium arsenide, silicon germanium, aluminum oxide (including its single crystal form of sapphire), gallium nitride, zinc oxide, zinc sulfide, gallium indium arsenide, indium antimonide, germanium, yttrium barium oxides, lanthanide oxides, magnesium oxide, calcium oxide, and other semiconductors, oxides, and intermetallics with a liquid phase. In addition, a number of other group III-V or group II-VI materials, as well as metals and alloys, could be cast according to embodiments of the present invention.

Cast silicon includes multicrystalline silicon, near multicrystalline silicon, geometric multicrystalline silicon, and/or monocrystalline silicon. Multicrystalline silicon refers to crystalline silicon having about a centimeter scale grain size distribution, with multiple randomly oriented crystals located within a body of multicrystalline silicon.

Geometric multicrystalline silicon or geometrically ordered multicrystalline silicon refers to crystalline silicon having a nonrandom ordered centimeter scale grain size distribution, with multiple ordered crystals located within a body of multicrystalline silicon. The geometric multicrystalline silicon may include grains typically having an average about 0.5 centimeters to about 5 centimeters in size and a grain orientation within a body of geometric multicrystalline silicon can be controlled according to predetermined orientations, such as using a combination of suitable seed crystals.

Polycrystalline silicon refers to crystalline silicon with micrometer to millimeter scale grain size and multiple grain orientations located within a given body of crystalline silicon. Polycrystalline silicon may include grains typically having an average of about submicron to about micron in size (e.g., individual grains are not visible to the naked eye) and a grain orientation distributed randomly throughout.

Monocrystalline silicon refers to crystalline silicon with very few grain boundaries since the material has generally and/or substantially the same crystal orientation. Monocrystalline material may be formed with one or more seed crystals, such as a piece of crystalline material brought in contact with liquid silicon during solidification to set the crystal growth. Near monocrystalline silicon refers to generally crystalline silicon with more grain boundaries than monocrystalline silicon but generally substantially fewer than multicrystalline silicon.

Silicon of the above described types and kinds may be cast and/or formed into blocks, ingots, bricks, wafers, any suitable shape or size, and/or the like. The silicon may include a positive or negative dopant, for altering the electrical properties of the silicon.

The high purity silicon made with this invention may include any suitable level of reduced impurities. Impurities broadly include carbon, silicon carbide, silicon nitride, oxygen, other metals, and/or substances which generally reduce an efficiency of a solar cell or a solar module. The ingot may include a carbon concentration of about 2×10¹⁶ atoms/centimeter cubed to about 5×10¹⁷ atoms/centimeter cubed, an oxygen concentration not exceeding about 7×10¹⁷ atoms/centimeter cubed, and a nitrogen concentration of at least about 1×10¹⁵ atoms/centimeter cubed. Desirably, the ingot may further be substantially free from radially distributed defects, such as made without the use of rotational (spinning) processes and/or pulling.

High temperature broadly includes elevated or increased temperatures, such as at least about 500 degrees Celsius, at least about 1,000 degrees Celsius, at least about 1,400 degrees Celsius, at least about 1,420 degrees Celsius (melting point of silicon), at least about 1,450 degrees Celsius, at least about 1,500 degrees Celsius, and/or any other suitable number or range.

According to one embodiment, this invention may include a gas circulating heat exchanger suitable for use in producing high purity silicon. The exchanger may include a hot surface for thermal contact with a crucible along with an inlet for flowing a gas to the heat exchanger and an outlet for flowing the gas from the heat exchanger. The invention may include a baffle dividing the inlet from the outlet and for directing at least a portion of the gas onto, against, along, and/or over the hot surface, and a recirculation system adapted to cool the gas and return the gas to the heat exchanger.

The term “heat exchanger” broadly refers to a device for transferring heat (enthalpy) or temperature (internal energy) from one substance to another substance, such as without allowing the substances to mix. Heat exchangers can be used for heating and/or cooling. Heat exchangers may include any suitable size, shape, configuration, material of construction, and/or the like.

The term “hot surface” broadly refers to a portion of the heat exchanger contacting a heat source, such as a bottom of a crucible containing molten feedstock or silicon, solidified product or an ingot (elevated temperature), and/or the like. Desirably, but not necessary, the hot surface conveys, transfers, and/or allows the flow of heat from the crucible to a heat transfer fluid, such as a gas. The hot surface may include any suitable size and/or shape. The hot surface may include a generally planar exterior, a generally flat outside, and/or any other suitable shape to contact the heat source. The hot surface may include a generally square shape, a generally rectangular shape, and/or the like. In the alternative, the hot surface may at least somewhat substantially conform to a portion of the crucible, such as a bottom and portion of the sides to form a depression in the hot surface.

The term “thermal contact” broadly refers to two or more items being able to pass, transfer, and/or exchange temperature or enthalpy from one item to another. Desirably, thermal contact includes little thermal resistance and/or insulation in between. Thermal contact may include both direct and indirect methods.

The term “inlet” broadly refers to a supply or source, such as a flow of a material. The inlet may include any suitable size, location, number, and/or shape. According to one embodiment, the inlet may be centrally located with respect to the hot surface and generally on an opposite side of the heat exchanger from the hot surface. The inlet may be configured with respect to the hot surface to provide a generally concurrent, counter current, and/or any other suitable arrangement of flow. Desirably, the inlet may be disposed or located with respect to a middle of a bottom of the crucible, such as the area of greatest cooling. A central inlet may contact the coldest gas and/or greatest mass of gas with the center of the hot surface.

The term “outlet” broadly refers to an effluence or exit, such as a flow of a material. The outlet may include any suitable size, location, number, and/or shape. According to one embodiment, the heat exchanger may include 4 outlets disposed with respect to each corner of a generally rectangular shaped hot surface. The outlet may be in fluid communication with the inlet, such as separated by a baffle to distribute a flow of the heat transfer fluid or the gas and direct contact with and/or against the hot surface.

The term “gas” broadly refers to a substance not in the solid phase or the liquid phase at the operating temperatures and pressures of the heat exchanger. Gases may include substances without a definite shape and volume. The gases may include any suitable substances for transferring enthalpy. Desirably, the gas may be at least somewhat inert with respect to molten silicon and the related casting equipment, such as graphite at high temperatures. The inert gas may include helium, argon, nitrogen, and/or any other suitable substance.

A flow rate of the gas may include any suitable amount, such as between about 5 kilograms per hour and about 10,000 kilograms per hour, between about 100 kilograms per hour and about 5,000 kilograms per hour, between about 1,000 kilograms per hour and about 1,500 kilograms per hour, about 1,250 kilograms per hour, and/or the like.

The term “flow” broadly refers to issuing or moving, such as in a stream. The flow may be movement from a first location to a second location. The flow may also be a circulation, such as to move with a continual change of place among the constituent particles or portions of the gas.

The term “baffle” broadly refers to a device to deflect, direct, check, regulate, and/or accelerate flow or passage, such as a fluid. The baffle may divide or separate the inlet from the outlet, such as to prevent short circuiting. Desirably, the baffle may direct or guide at least a portion of the flow of the gas or heat transfer fluid over, across, and/or against at least a portion of the hot surface, such as for removing heat from the hot surface. The baffle may cause the gas to impinge or contact the hot surface at any suitable angle, such as generally perpendicular to the hot surface.

The term “recirculation system” broadly refers to devices to cool the gas or heat transfer fluid from the outlet of the heat exchanger (silicon cooler) and return the cooled gas or heat transfer fluid to the inlet of the heat exchanger. The recirculation system may include a circulating device or a motive force device, such as a centrifugal blower, a regenerative blower, a vacuum pump, a liquid ring vacuum pump, an eductor, an ejector, and/or the like. Desirably, the circulating device includes a variable flowrate, such as by changing a motor speed, adjusting a damper, and/or the like. The recirculation system may include a heat sink, such as a cooler, a heat exchanger, and/or the like. The heat sink may use a heat transfer fluid, cooling water, boiler feedwater, and/or any other suitable fluid or medium to remove enthalpy. In the alternative, the recirculation system combines with a second casting station, such as for preheating of the solid feedstock.

The motive force device may include any sufficient volumetric flowrate, developed head or pressure, and/or the like. According to one embodiment, the motive force device produces between about 10 centimeters to about 50 centimeters of water column discharge pressure. Desirably, the motive force device may include equipment with a relativity low discharge head and a high volume throughput.

The heat exchanger (silicon cooler) may include or be made of any suitable materials, such as graphite, silicon carbide, high temperature ceramic, refractory, silicon nitride, silica, aluminum oxide, aluminum nitride, aluminum silicate, boron nitride, zirconium phosphate, zirconium diboride, hafnium diboride, and/or the like.

According to one embodiment, the heat exchanger may include a perforated plate or other suitable device to distribute the gas with respect to the hot surface, such as to prevent short circuiting from the inlet to the outlet. Desirably, the perforated plate at least generally has a similar size and/or shape to the hot surface, such as may be positioned with respect to a bottom side of the hot surface or generally opposite a crucible. The perforated plate may include a plurality of holes or apertures, such as to form a mesh or a grid, for example. The perforated plate may include any suitable number, size and/or shape of holes, such as at least about 5 across a width, at least about 10 across a width, at least about 15, across a width, at least about 20 across a width, at least about 50 across a width, and/or the like.

The perforated plate may be separated from the hot surface by any suitable distance, such as about 0.01 times a width of the perforated plate, about 0.05 times a width of the perforated plate, about 0.1 times a width of the perforated plate, and/or the like. A portion of the perforated plate desirably at least generally or substantially parallels at least a portion of the hot surface.

Desirably, the holes, apertures, or jets sufficiently distribute a flow of the gaseous heat transfer fluid without excessive pressure drop or head loss. The apertures may include a generally square shape, a generally rectangular shape, a generally circular shape, a generally oval shape, any other suitable shape, and/or the like. According to one embodiment, the jets cause impingement of the gas against the hot surface.

The perforated plate may create a substantially equal pressure drop across the gas or heat transfer fluid flow path of the heat exchanger, such as to direct flow to impinge on, against, and/or along the hot surface. Impinge broadly may include directing at least a portion of a heat transfer fluid generally perpendicular or at right angles to a surface for cooling and/or heating. Desirably, impingement cooling includes an increase in turbulence (non-laminar flow) and/or an increase in a heat transfer coefficient versus parallel convection flows. Optionally and/or additionally, a portion of the gas flow may also be generally parallel to the hot surface, such as after impingement and while flowing to the outlet.

The size or diameter of the openings of the perforated plate can vary with location, such as to optimize the pressure drop and/or the flow characteristics. Likewise, the location and opening density can change to tailor the local heat removal characteristics for optimum crystal growth. Local broadly refers to a specific or targeted region or area. Desirably, but not necessarily, all the gas or heat transfer fluid may include about the same amount of temperature increase from the inlet to the outlet of the heat exchanger.

According to one embodiment, the spacing and/or density of apertures of the perforated plate may include a semi-log relationship, such as where the openings nearest the center have a diameter and the apertures at the edge or border have an increased and/or decreased diameter or spacing (jet density). The different diameters may adjust for pressure drop and/or remove additional or less heat along the edge according the geometry of the crucible (thermal conducting sidewalls). Other configurations of gradients for holes are within the scope of this invention.

Desirably, the heat removed allows controlled but rapid crystallization to form a quality ingot, such as with a generally constant temperature profile and/or generally constant heat flux across or through the hot surface. In the alternative, the heat removed may include at least somewhat substantial temperature gradients or profiles.

The ratio of diameter of the apertures at the center to the apertures at the edge may include any suitable amount, such as about 0.01 to about 1.0, about 0.05 to about 1.0, about 0.1 to about 1.0, about 0.5 to about 1.0, about 1.0 to about 1.0, about 1.0 to about 1.1, about 1.0 to about 1.5, about 1.0 to about 2.0, about 1.0 to about 1.0 to about 5.0, about 1.0 to about 10.0, about 1.0 to about 20, about 1.0 to about 50, and/or the like. The changing diameter apertures may progress in size generally incrementally in a continuous and/or a stepwise manner.

The perforated plate may include any suitable percent open area (total area of apertures or holes over the total area of the plate), such as at least about 20 percent, at least about 50 percent, at least about 75 percent, at least about 85 percent, at least about 95 percent, and/or the like. The perforated plate may include any suitable thickness, such as at least about 0.5 centimeters, at least about 1 centimeter, at least about 2 centimeters, at least about 5 centimeters, and/or the like.

According to one embodiment, the heat exchanger may include an inlet header or a manifold having a generally triangular cross section or a generally conical cross section, and for delivering the gas to the hot surface from the inlet. The inlet header may include any suitable size and/or shape. The heat exchanger may include an outlet header having a generally square cross section or a generally rectangular cross section, and for receiving gas from the hot surface to the outlet. The outlet header may include any suitable size and/or shape.

The heat exchanger may include an inlet header or manifold having a generally triangular cross section or a generally conical cross section, such as for delivering the gas in a controlled pattern or manner from the inlet to the hot surface. The heat exchanger may also include an outlet header or manifold, such as for receiving the gas in a controlled pattern or manner from the hot surface and conveying the gas to the outlet. Controlled pattern broadly refers to flows designed to produce desired hydraulic and/or heat transfer characteristics or results.

The heat exchanger may be fabricated or constructed in any suitable manner, such as from individual components or pieces. Blocks or bricks of graphite may be machined, cut, sawed, and/or shaped into the desired structure or form. The graphite components may be assembled by any suitable chemical or mechanical device or system, such as graphite nuts and bolts, joined with pitch and heated to remove volatiles, and/or the like. In the alternative, the graphite blocks may be placed with respect to each other without mechanical or chemical fasteners, such as the weight of the crucible and feedstock placed on top of the heat exchanger hold the pieces in place. The blocks may be assembled in a suitable layered structure, such as about 1 layer, about 2 layers, about 3 layers, about 4 layers, about 5 layers, about 10 layers, and/or the like. The blocks or a portion of the blocks may include a tongue and groove joint or interface, such as where a lower block includes a raised portion corresponding generally to a recessed portion in an upper block. Other configurations of blocks or pieces are within the scope of this invention.

According to one embodiment, the invention may include a casting apparatus suitable for use in producing high purity silicon. The apparatus may include a crucible for containing a feedstock, and a first heat exchanger in thermal contact with at least a portion of the crucible. The apparatus may also include a second heat exchanger in thermal contact with a heat sink and in fluid communication with the first heat exchanger. The apparatus may also include a motive force device in fluid communication with the first heat exchanger and the second heat exchanger, for circulating a gaseous heat transfer fluid.

The term “casting apparatus” broadly refers a device used at any location and/or step of the casting process, such as during a melting step, during a superheating step, during a refining step, during a purification step, during a holding step, during an accumulating step, during a solidification step, during a crystallization step, and/or the like. The scope of this invention includes single vessel casting processes, as well as multi-vessel casting processes, for example, 3 stages with separate melting, holding, and solidifying.

The first heat exchanger may include any of the characteristics and/or qualities discussed above with respect to the heat exchanger of the previously identified embodiments.

The term “crucible” or “process vessel” broadly refers to a device of refractory material or the like used for melting and/or heating up a substance that requires a high degree of heat.

The second heat exchanger may include any suitable device, such as device for thermally contacting two fluids with indirect heat exchange. According to one embodiment, the second heat exchanger includes a double pipe design, a shell and tube design, a fin design, and/or the like. The second heat exchanger may include concurrent flow, countercurrent flow, and/or the like.

According to one embodiment, the heat sink may include air, cooling water, boiler feedwater, steam, high temperature heat transfer fluid, brine solutions, chilled water, refrigerant, dry ice, liquid nitrogen, and/or the like. Using air as a heat sink may include rejecting heat to the surroundings of the casting apparatus, and/or to the outside of a building, for example. Desirably, since there is not a path for molten silicon to contact the heat sink a wider variety of substances and/or temperature ranges may be used.

Cooling water may broadly include aqueous substances in once through or recirculation, such as with a cooling tower. Desirably, the cooling water under goes a change in temperature, such as by increasing sensible heat.

Boiler feedwater may include a more pure aqueous substance, such as for undergoing a temperature change or a phase change (liquid to vapor). Steam may include water vapor and may become superheated with the addition of heat above the boiling point. Steam may be used in a steam engine, a turbine, a microturbine and/or the like for generating electric power, for example.

High temperature heat transfer fluids broadly includes other solutions and/or chemistries for transferring thermal energy from one place to another, such as glycols, mineral oils, silicones, and/or the like.

According to one embodiment, the apparatus may include a seed layer on a bottom and/or at least one side of the crucible. The seed layer may include a crystal or group of crystals with desired crystal orientations that form a continuous layer. The seed layer may be made to conform to one or more sides of a crucible for casting purposes. Desirably, at least a portion of the crucible in thermal contact with the first heat exchanger includes at least a portion corresponding to the seed layer, such as the bottom of the crucible, for example.

The first heat exchanger and the second heat exchanger may be physically isolated from each other, such as by a physical space and corresponding pipes or conduits for thermal communication and/or fluid communication. In the alternative, the first heat exchanger and the second heat exchanger may be integral and/or unitary with each other. The second heat exchanger may be located at a higher elevation and/or generally above (desirably not directly on top of) the first heat exchanger, such as to avoid contact of breaching liquid silicon with the heat sink. The second heat exchanger may be outside of the insulation of the casting apparatus.

According to one embodiment, the second heat exchanger may include a cascade of heat exchangers rejecting heat to different media for heat integration, such as to optimize heat values. One potential cascade may include superheating steam from saturated steam, generating steam from preheated boiler feedwater, preheating boiler feedwater, and/or warming cooling water. Optimum heat values allow for keeping higher heat values or temperatures and not degrading them to a lower heat value with out gaining benefit. Other cascades and arrangements of heat sinks are within the scope of the invention.

As used herein the terms “having”, “comprising”, and “including” are open and inclusive expressions. Alternately, the term “consisting” is a closed and exclusive expression. Should any ambiguity exist in construing any term in the claims or the specification, the intent of the drafter is toward open and inclusive expressions.

Regarding an order, number, sequence and/or limit of repetition for steps in a method or process, the drafter intends no implied order, number, sequence and/or limit of repetition for the steps to the scope of the invention, unless explicitly provided.

According to one embodiment, this invention may include a method of cooling a material suitable for use in producing high purity silicon. The method may include the step of contacting thermally a first heat exchanger with at least a portion of a crucible, and the step of flowing a gaseous heat transfer fluid through the first heat exchanger with a motive force device. The method may include the step of heating the gaseous heat transfer fluid in the first heat exchanger to cool a material within the crucible by conducting heat through the at least a portion of the crucible and the first heat exchanger, and the step of flowing the gaseous heat transfer fluid to a second heat exchanger. The method may also include the step of cooling the gaseous heat transfer fluid in the second heat exchanger by contacting thermally with a heat sink, and the step of repeating the above steps to recirculate the gaseous heat transfer fluid, as needed.

According to one embodiment, the invention may include a method of cooling a material suitable for use in producing high purity silicon. The method may include the step of contacting thermally a first heat exchanger with at least a portion of a crucible, and the step of flowing a gaseous heat transfer fluid through the first heat exchanger with a motive force device, wherein the flowing passes through an inlet header for a tailored gas flow and the flowing passes through an outlet header for a tailored gas flow. The method may also include the step of heating the gaseous heat transfer fluid in the first heat exchanger to cool a material within the crucible by conducting heat through the at least a portion of the crucible and the first heat exchanger, and the step of flowing the gaseous heat transfer fluid to a second heat exchanger. The method may also include the step of cooling the gaseous heat transfer fluid in the second heat exchanger by contacting thermally with a heat sink, and the step of repeating above steps to recirculate the gaseous heat transfer fluid. Tailored gas flow broadly refers to any suitable flow shaped, patterned, influenced and/or the like. Tailored gas flows may provide localized heat transfer capabilities and/or attributes.

The step of contacting thermally a first heat exchanger with at least a portion of a crucible may include placing or aligning a planar portion of a hot surface with a bottom section of a crucible. Desirably, the hot surface and the crucible contact each other well and the weight of the crucible and the feedstock may increase contact between the items. Other nesting or shaped geometries are within the scope of this invention. The crucible may be located on an opposite side of the hot surface from the perforated plate.

The step of flowing a gaseous heat transfer fluid in or through the first heat exchanger with a motive force device may include supplying fresh or make up gas, such as from an inert gas supply. The flowing may be in or through a suitable pipe, tubing, conduit, duct, pathway, and/or the like. In the alternative, the gaseous heat transfer fluid may include recycled or reused material, such as returning from a cooler. Embodiments of “loop” cooling are within the scope of this invention. Fresh gaseous heat transfer fluid may include a lower temperature, such as from a vaporizer supplied from a pressurized source, a liquefied source, or a cryogenic source. Flowing may include any suitable flowrate and/or pressure, such as needed to remove the heat of fusion from the silicon within the crucible.

The step of heating the gaseous heat transfer fluid in the first heat exchanger to cool a material within the crucible by transferring or flowing heat through the at least a portion of the crucible and the first heat exchanger may include any suitable temperature difference. Generally the larger the temperature difference between the hot crucible and the gaseous heat transfer fluid, the more energy can be transferred. The temperature difference may be at least about 10 degrees Celsius, at least about 100 degrees Celsius, at least about 250 degrees Celsius, at least about 500 degrees Celsius, at least about 750 degrees Celsius, at least about 1,000 degrees Celsius, and/or the like.

Heat transfer (heating and/or cooling) may occur by convection, conduction, radiation, evaporation, other suitable phase changes, and/or the like. The heat transfer portion of the crucible may include the bottom, a portion of the sides, and/or the like. Desirably, the cooling of the material within the crucible results in solidified or crystallized silicon, such as in the forms discussed above.

The step of flowing the gaseous heat transfer fluid to a second heat transfer exchanger may include the characteristics described above with respect to the step of flowing the gaseous heat transfer fluid through the first heat exchanger, except the heat is rejected rather than collected, for example.

Additional processing steps and/or equipment may be used with the gaseous heat transfer fluid, such as filters, oxygen scavengers, cold traps, desiccants, and/or the like. The additional equipment or steps may be at any suitable location, such as on a suction or a discharge of the motive force device.

The step of cooling the gaseous heat transfer fluid in the second heat exchanger by contacting thermally with a heat sink may include any suitable steps to reduce a temperature of the gaseous heat transfer fluid. The cooling may be by convection, conduction, radiation, and/or the like. The cooling may be by indirect heat exchange between one or more streams with the gaseous heat transfer fluid.

The step of repeating the above steps to recirculate or recycle the gaseous heat transfer fluid may include forming a loop and/or a closed circuit. The loop may include any suitable volume and/or flowrate. Desirably, the flowrate can be varied during the casting process, such having a relatively small flow for cooling to maintain the seed layer during heating, and having a relatively larger flow during cooling for solidification following melting.

According to one embodiment, a temperature of the gaseous heat transfer fluid before the first exchanger may include any suitable value, such as less than about 100 degrees Celsius, less than about 300 degrees Celsius; less than about 500 degrees Celsius, and/or the like. A temperature of the gaseous heat transfer fluid before the second heat exchanger may include any suitable value, such as at least about 250 degrees Celsius, at least about 500 degrees Celsius, at least about 750 degrees Celsius, at least about 1,000 degrees Celsius, and/or the like.

A change in temperature of the gaseous heat transfer fluid across (inlet to outlet) the first heat exchanger may include at least about 50 degrees Celsius, at least about 100 degrees Celsius, at least about 250 degrees Celsius, at least about 500 degrees Celsius, at least about 750 degrees Celsius, and/or the like.

The gaseous heat transfer fluid may include any suitable substance, such as a gas that is inert with respect to materials of the heat exchangers at the operating temperatures and/or ranges. According to one embodiment, the gaseous heat transfer fluid may include argon, helium, nitrogen, mixtures or combinations thereof, and/or the like.

The ratio of gases in a mixture may include any suitable amount, such as for binary mixtures about 95:5, about 90:10, about 80:20, about 70:30, about 60:40, about 50:50, and/or the like. The ratio may be measured in any suitable manner, such as on a molar basis, on a mass basis, on a volume basis (at standard conditions or at actual conditions), and/or the like. Mixtures of three or more gases in any suitable ratios are within the scope of this invention. According to one embodiment, the gas mixture includes 90 volume percent argon and 10 volume percent helium, such as having a higher heat transfer coefficient than either argon or helium alone.

According to one embodiment, the method may also include the step of distributing the gaseous heat transfer fluid across or along a hot surface of the first heat exchanger with a perforated plate, as discussed above.

According to one embodiment, the step of flowing the gaseous heat transfer fluid through the first heat exchanger may include the step of flowing the gaseous heat transfer fluid through an inlet of the first heat exchanger, and the step of flowing the gaseous heat transfer fluid through an inlet header having a generally triangular cross section, a generally conical, and/or other suitable shape, such as to distribute the flow to the perforated plate and/or the hot surface. The step of flowing the gaseous heat transfer fluid through the first heat exchanger may also include the step of flowing the gaseous heat transfer fluid across a hot surface with a generally planar exterior, and a generally square shape or a generally rectangular shape. A baffle may divide the inlet header from an outlet header. The step of flowing the gaseous heat transfer fluid through the first heat exchanger may also include the step of flowing the gaseous heat transfer fluid through the outlet header having a generally square cross section or a generally rectangular cross section, and the step of flowing the gaseous heat transfer fluid through an outlet of the first heat exchanger.

According to one embodiment, the step of heating of the gaseous heat transfer fluid in the first heat exchanger may include the heat removal needed to cool, solidify, and/or crystallize a molten or liquid feedstock, such as to form monocrystalline silicon, multicrystalline silicon, and/or the like. Desirably, the rate of cooling may be varied during different stages of the casting process, such as no cooling during melting and full cooling during solidification. In the alternative, the cooling may be on during the melting stage, such as to maintain a portion of the seed layer from melting. Modulating or varying levels of cooling are within the scope of this invention, such as a first level of cooling during initial solidification and a second greater level of cooling near completion of solidification.

According to one embodiment, this invention may include a process or method of operating the gas cooling loop at a higher (increased) pressure than that of the gas in contact with the silicon (molten or solid). The increased pressure may provide enhanced heat transfer capability (heat transfer coefficients of gases increase with pressure) and may provide any leaks of gas would be from the cooling loop outwards, such as to prevent ingress or entrance of silicon monoxide contaminated gas into the cooling heat exchanger loop. Silicon monoxide can react with graphite or carbon components to form carbon monoxide which can contaminate the silicon and/or reduce operating life of the components. Silicon monoxide ingress can also cause deposition on the inner surfaces of heat transfer components creating a boundary layer coating that decreases heat transfer efficiency. Operation at a higher relative pressure to the silicon environment attempts to avoid this degradation.

The pressure differential may be at any suitable amount, such as at least about 2 centimeters of water column absolute, at least about 10 centimeters of water column absolute, at least about 100 centimeters of water column absolute, and/or the like. The operating pressure of the cooling loop may be at any suitable pressure, such as about at least about 5 centimeters of water column absolute, about 100 centimeters of water column absolute, about 500 centimeters of water column absolute, about 1,000 centimeters of water column absolute, about 5,000 centimeters of water column absolute, about 10,000 centimeters of water column absolute, and/or the like.

Desirably, the gas recirculating heat exchanger of this invention may be used during many casting cycles, such as at least about 1,000 hours of operation, at least about 5,000 hours of operation, at least about 10,000 hours of operation, and/or the like.

### EXAMPLE

The gas recirculation heat exchanger according to one embodiment of this invention was modeled using computational fluid dynamics. Argon was used as the gaseous heat transfer fluid and had a flow rate of 1,248 kilograms per hour at 260 degrees Celsius and atmospheric pressure. The heat exchanger was modeled using graphite with a thermal conductivity of 117.7 watt per meter per Kelvin at 20 degrees Celsius, 51.0 watt per meter per Kelvin at 200 degrees Celsius, 40.8 watt per meter per Kelvin at 500 degrees Celsius, and linearly interpolated between these three points. Non-porous carbon was modeled using a thermal conductivity of 10.4 watt per meter per Kelvin. The emissivity of the graphite was 0.8. All external surfaces were modeled as adiabatic with the exception of the heated top surface, which was modeled with a heat flux of 40 kilowatts. The inlet and the outlet were modeled at the local fluid temperature. The heat exchanger was modeled in ⅛ symmetry, that is a triangular wedge (piece of pie). The model included heat transfer by radiation.

The result of the modeling was 40 kilowatts of power delivered to the gas with an average gas exit temperature of 477 degrees Celsius and a static pressure drop of 35.1 millibar. The model showed the gas from the central inlet supply distributed by the baffle and the perforated plate. The top hot surface had a temperature gradient ranging from about 754 degrees Celsius of about 25 percent of the area to about 718 degrees Celsius at the corners and the extreme sides. About 50 percent the area under the perforated plate near the entrance had a temperature of about 260 degrees Celsius. The velocity of the gas showed over about 90 percent of the gas through the perforated plate with about the same pressure drop. Only the portion of the perforated plate directly under the inlet showed a roughly double in magnitude pressure drop. The gas had an average velocity in the inlet header of about 22.9 meters per second and an average velocity through the openings of the perforated plate of about 76.2 meters per second.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

What is claimed is:

1. A gas circulating heat exchanger suitable for use in producing high purity silicon, the exchanger comprising:
a hot surface for thermal contact with a crucible;
an inlet for flowing a gas to the heat exchanger;
an outlet for flowing the gas from the heat exchanger;
a baffle dividing the inlet from the outlet and for directing at least a portion of the gas onto the hot surface; and
a recirculation system adapted to cool the gas and return the gas to the heat exchanger.

2. The exchanger of claim 1, wherein the heat exchanger comprises graphite.

3. The exchanger of claim 1, wherein the hot surface comprises a generally planar exterior, and a generally square shape or a generally rectangular shape.

4. The exchanger of claim 1, further comprising a perforated plate to distribute the gas with respect to the hot surface.

5. The exchanger of claim 1, further comprising:
an inlet header having a generally triangular cross section or a generally conical cross section, and for delivering the gas in a controlled pattern from the inlet to the hot surface; and
an outlet header for receiving the gas in a controlled pattern from the hot surface and conveying the gas to the outlet.

6. The exchanger of claim 1, wherein:
the inlet comprises a central gas entry; and
the outlet comprises one or more gas exits.

7. The exchanger of claim 1, wherein the recirculation system comprises a cooler and a circulating device.

8. The exchanger of claim 7, wherein the circulating device has a variable flowrate.

9. A casting apparatus suitable for use in producing high purity silicon, the apparatus comprising:
a crucible for containing a feedstock;
a first heat exchanger in thermal contact with at least a portion of the crucible; the first heat exchanger comprises a graphite hot surface for contact with the crucible, an inlet for flowing the gaseous heat transfer fluid to the heat exchanger, an outlet for flowing the gaseous heat transfer fluid from the heat exchanger, and a baffle dividing the inlet from the outlet and for directing at least a portion of the gaseous heat transfer fluid onto the hot surface;
a second heat exchanger in thermal contact with a heat sink and in fluid communication with the first heat exchanger; and
a motive force device in fluid communication with the first heat exchanger and the second heat exchanger, for circulating a gaseous heat transfer fluid.

10. The apparatus of claim 9, wherein the first heat exchanger further comprises a perforated plate to distribute the gas with respect to the crucible.

11. The apparatus of claim 9, wherein:
the second heat exchanger comprises a shell and tube design; and
the heat sink comprises cooling water, boiler feedwater, or high temperature heat transfer fluid.

12. The apparatus of claim 9, wherein the motive force device comprises a centrifugal blower, a regenerative blower, or a vacuum pump.

13. The apparatus of claim 9, further comprising a seed layer on a bottom of the crucible and the at least a portion of the crucible in thermal contact with the first heat exchanger comprises the bottom of the crucible.

14. The apparatus of claim 9, wherein the first heat exchanger and the second heat exchanger are physically isolated from each other.

15. The apparatus of claim 9, wherein the second heat exchanger comprises a cascade of heat exchangers rejecting heat to different media for heat integration.

16. A method of cooling a material suitable for use in producing high purity silicon, the method comprising:
contacting thermally a first heat exchanger with at least a portion of a crucible;
flowing a gaseous heat transfer fluid through the first heat exchanger with a motive force device, wherein the flowing gas passes through an inlet header to tailor flow characteristics and the flowing gas passes through an outlet header to tailor flow characteristics;
heating the gaseous heat transfer fluid in the first heat exchanger to cool a material within the crucible by conducting heat through the at least a portion of the crucible and the first heat exchanger;
flowing the gaseous heat transfer fluid to a second heat exchanger;
cooling the gaseous heat transfer fluid in the second heat exchanger by contacting thermally with a heat sink; and
repeating above steps to recirculate the gaseous heat transfer fluid.

17. The method of claim 16, wherein:
a temperature of the gaseous heat transfer fluid before the first exchanger comprises less than about 300 degrees Celsius; and
a temperature of the gaseous heat transfer fluid before the second heat exchanger comprises at least about 500 degrees Celsius.

18. The method of claim 16, wherein the gaseous heat transfer fluid comprises argon, helium, nitrogen or combinations thereof.

19. The method of claim 16, further comprising a distributing the gaseous heat transfer fluid against a hot surface of the first heat exchanger with a perforated plate.

20. The method of claim 16, wherein the flowing the gaseous heat transfer fluid through the first heat exchanger comprises:
flowing the gaseous heat transfer fluid through an inlet of the first heat exchanger;
wherein the inlet header has a generally triangular cross section or a generally conical cross section;
flowing the gaseous heat transfer fluid onto or across a hot surface with a generally planar exterior, and a generally square shape or a generally rectangular shape, wherein a baffle divides the inlet header from an outlet header;
wherein the outlet header has a generally square cross section or a generally rectangular cross section; and
flowing the gaseous heat transfer fluid through an outlet of the first heat exchanger.

21. The method of claim 16, wherein the heating of the gaseous heat transfer fluid in the first heat exchanger comprises the heat removal needed to solidify a molten feedstock or cool a solid product.
